(19) United States
(12) Patent Application Publication
(10) Pub. No.: US 2005/0081973 A1
(43) Pub. Date: Apr. 21, 2005

(54) Inflatable wheel assembly

(75) Inventor: Thierry Marin-Martinod, Nesles-La-Vallee (FR)

Correspondence Address: YOUNG & THOMPSON, 745 SOUTH 23RD STREET, 2ND FLOOR, ARLINGTON, VA, 22202, US

(73) Assignee: Messier-Bugatti, Velizy Villacoublay (FR)

(21) Appl. No.: 10/500,578

(22) PCT Filed: Jan. 9, 2003
(86) PCT No.: PCT/FR03/00057

(30) Foreign Application Priority Data
Jan. 11, 2002 (FR) 02/00334

(51) Int. Cl. B60C 23/10

(52) U.S. Cl. 152/415

(57) ABSTRACT

A wheel assembly for a vehicle, includes a wheel rim (16) and a tire (18) defining a closed space (30) therebetween which is filled with a pressurized gas. The inventive wheel assembly also includes a pressurized-gas reservoir (40) and elements (50) for selectively connecting the pressurized-gas reservoir (40) to the closed space (30) defined between the wheel rim (16) and the tire (18). The pressurized-gas reservoir (40) is rotationally fixed to the wheel rim (16).

The present invention relates to an inflatable wheel assembly, of the type comprising a rim and a tire defining between them a closed space filled with gas under pressure, a reservoir of gas under pressure, and means for selectively connecting the reservoir of gas under pressure to the closed space defined between the rim and the tire.

Vehicles are known that are fitted with wheels having pneumatic tires that include on-board installations for inflating the tires. For this purpose, the vehicle includes a reservoir of gas under pressure secured to the bodywork of the vehicle. A set of pipes fitted with valves connects the reservoir to each tire to enable the closed space defined inside each tire to be selectively connected to the reservoir of gas under pressure.

Because the wheel rotates, it is necessary to provide a rotary joint enabling the reservoir installed on the bodywork of the vehicle to be connected to the closed space defined by each rotary tire.

As a result, on-board inflation installations need to use mechanical elements that are very complex.

An object of the invention is to propose a wheel assembly that enables the tire to be reinflated and that is of simple structure.

To this end, the invention provides a wheel assembly of the above-specified type, characterized in that the reservoir of gas under pressure is constrained to rotate with the rim.

In particular embodiments, the wheel assembly includes one or more of the following characteristics:
the reservoir is filled with nitrogen;
the reservoir is disposed in the annular space defined between the tire and the rim;
the reservoir is fixed on the rim outside the annular space defined between the tire and the rim;
it includes a control unit connected to the means for selectively connecting the gas reservoir to the closed space to switch them between an open state and a closed state;
it includes a sensor for measuring the pressure inside said closed space, and said control unit is adapted to switch said connection means as a function of the pressure in said closed space;
it includes a temperature sensor, and said control unit is adapted to switch said connection means as a function of the temperature measured by the sensor;
said control unit comprises:
   a remote data processor unit that does not rotate with the rim;
   a controller for controlling the means for selectively connecting the reservoir to the closed space, said controller being constrained to rotate with the rim; and
   complementary wireless communications means connected firstly to said data processor unit and secondly to said controller to transmit commands from said data processor unit to the controller;
it includes complementary wireless communications means connected firstly to the or each sensor and secondly to said data processor unit for transmitting the measured values from the or each sensor to said data processor unit;
said complementary communications means comprise a rotary transformer comprising two windings mounted to rotate relative to each other, one of the windings being constrained to rotate with the rim;
said complementary communications means comprise two antennas one of which is constrained to rotate with the rim and the other of which is connected to the data processor unit and does not rotate with the rim, being situated remotely therefrom;
it includes means for selectively venting said closed space, said means being connected to said control unit to cause them to switch between an open state and a closed state; and
said means for selectively connecting the reservoir to said closed space and said means for selectively venting said closed space comprise a three-port valve with a first port connected to said closed space, a second port connected to the reservoir, and the third port connected to the atmosphere, the valve including a selector movable between a first position in which all three ports are closed, a second position in which the first and second ports are put into communication, while the third port is closed, and a third position in which the first and third ports are put into communication, while the second port is closed.

The invention will be better understood on reading the following description given purely by way of example and made with reference to the drawings, in which:

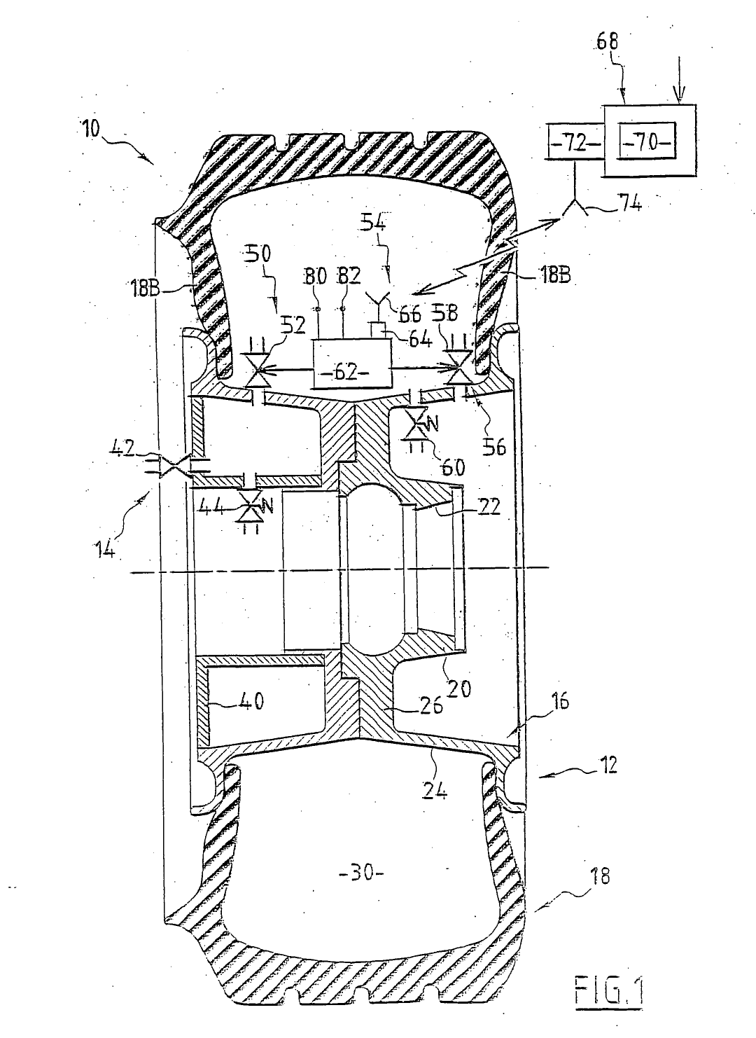

FIG. 1 is a diagrammatic longitudinal section view of a wheel assembly of the invention;

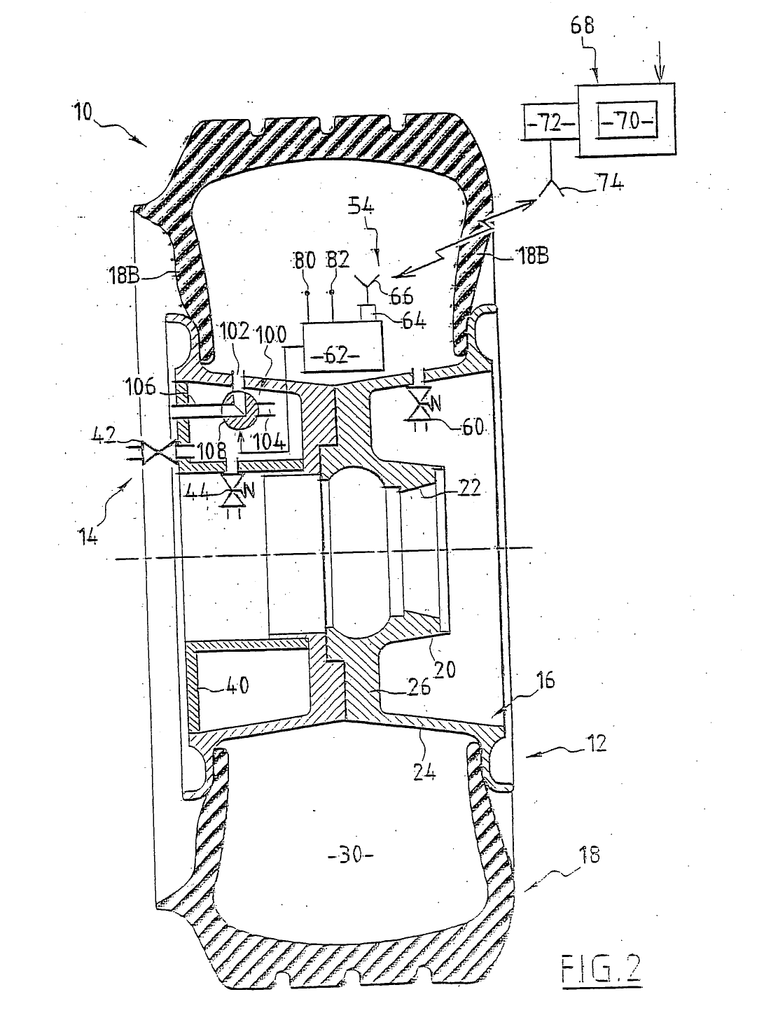

FIG. 2 is a view identical to FIG. 1 showing a first variant of the FIG. 1 wheel assembly;

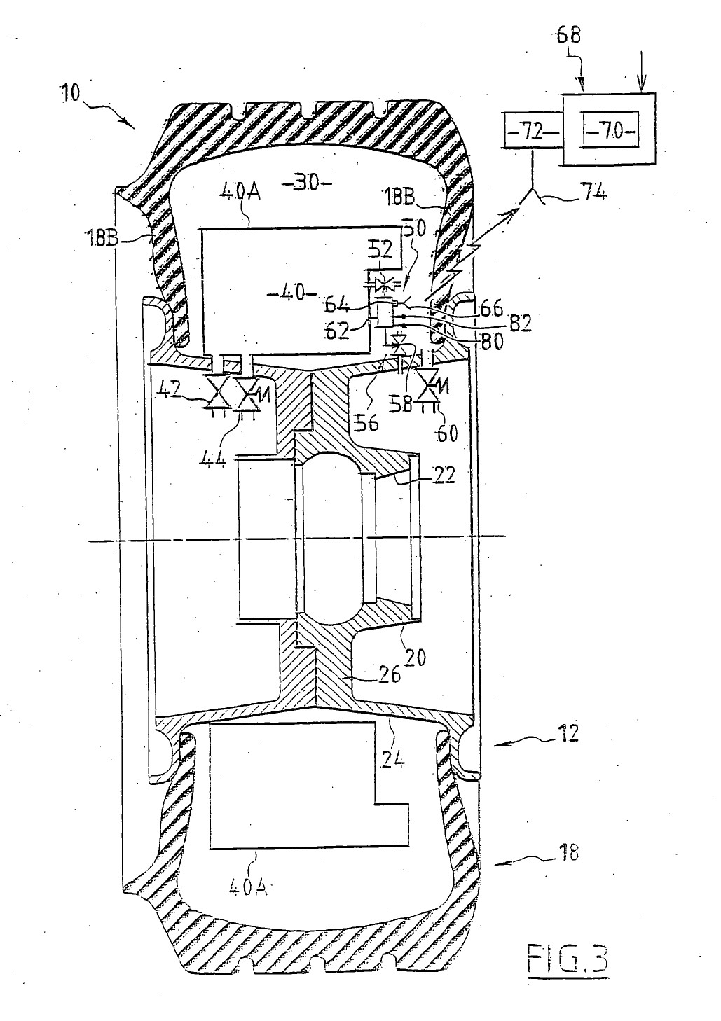

FIG. 3 is a view identical to that of FIG. 1 showing a second variant of the FIG. 1 wheel assembly; and

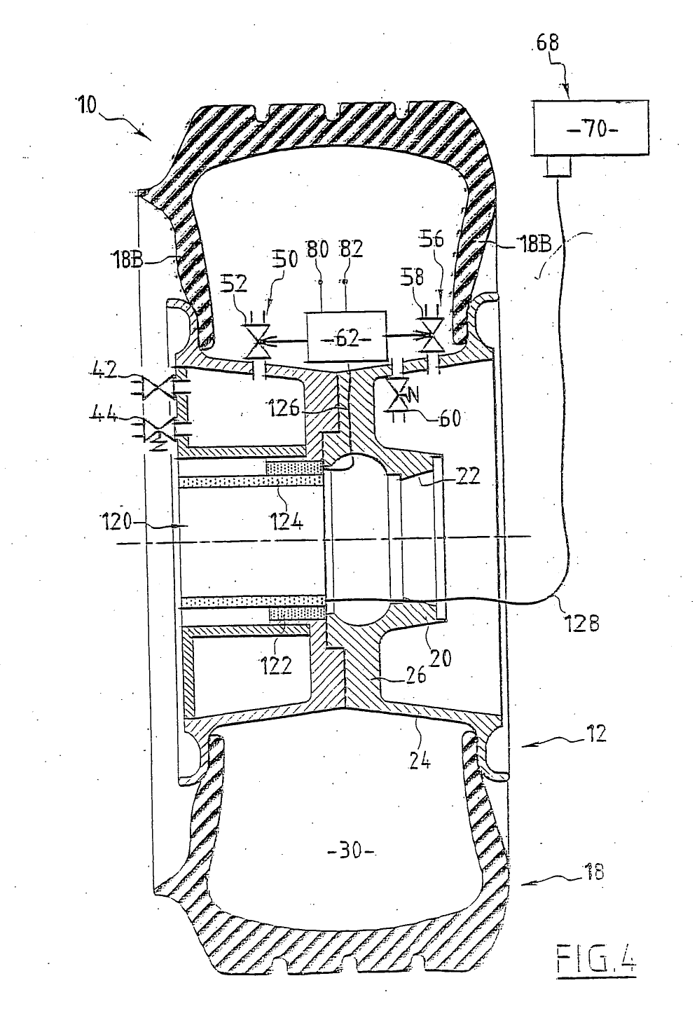

FIG. 4 is a view identical to that of FIG. 1, showing a third variant of the FIG. 1 wheel assembly.

The wheel assembly 10 shown in FIG. 1 is for use in the landing gear of an airplane. The wheel assembly comprises a wheel 12 and an on-board installation 14 for inflating the tire.

The wheel 12 comprises a rim 16 having a tire 18 mounted thereon. The rim 16 comprises a hub 20 having a through passage 22 in which there extends a wheel axle (not shown) secured to the landing gear of the airplane.

The rim 16 includes an outer ring 24 supporting the tire. The hub 20 and the ring 24 are interconnected by radial arms 26.

Between the outer ring 24 of the rim and the tire 12 there is defined a closed annular space 30 that is inflated with a gas under pressure such as air. The normal inflation pressure at a temperature of 25° C. is 15 bars, for example.

The on-board device 14 for inflating the tire comprises a reservoir 40 for storing a gas under pressure, in particular nitrogen, for inflating the tire 18. Initially, after it has been filled and before use, the pressure in the reservoir is 60 bars at a temperature of 25° C. The reservoir is constrained to rotate with the wheel 12, and more precisely with the rim 16.

The reservoir 40 is toroidal in shape and is fixed to the rim 26, e.g. removably by means of bolts. The reservoir 40 and the rim 16 are both disposed on the axis of the wheel.

The reservoir includes a filler valve 42 and a safety valve 44 adapted to allow gas to flow out from the reservoir when the pressure within the reservoir exceeds 95 bars.

In addition, means 50 are provided for putting the reservoir 40 and the closed space 30 selectively into communication with each other. These means 50 comprise a solenoid valve 52 providing a connection between the inside of the reservoir 40 and the closed space 30 through the outer ring 24 of the rim.

The solenoid valve 52 is connected to a control unit given overall reference 54.

Similarly, vent means 56 are implanted in the wheel assembly to enable the closed space 30 to be connected to the atmosphere. These means comprise a solenoid valve 58 providing a connection between the closed space 30 and the surrounding medium through the outer ring 24 of the rim. The solenoid valve 58 is also connected to the control unit 54.

In addition, a safety valve 60 is mounted through the ring 24 of the rim to ensure that the closed space 30 is automatically vented in the event of the pressure inside the tire exceeding 20 bars.

The control unit 54 includes a controller 62 constrained to rotate with the rim 16 and connected to the solenoid valves 52 and 58 in order to feed them with electricity to cause them to switch between an open state and a closed state. The controller 62 includes means for shaping the electrical signals fed to the solenoid valves to make them switch.

In addition, the controller 62 is connected to a communications interface 64 serving in particular to receive commands and to send measurement values. The interface 64 includes an antenna 66.

The control unit 54 also includes a data processor unit 68. This unit does not rotate with the rim 14, and for example it is fixed to the structure of the airplane.

This data processor unit 68 includes a computer 70. It is connected to a communications interface 72 fitted with an antenna 74 and suitable for establishing a both-way radio link with the communications interface 64 via the antenna 66.

The data processor unit 68 is connected to other functional elements of the airplane to receive reference tire pressures. The computer 70 is adapted to implement algorithms for issuing commands to the controller 62 as a function of the information it receives.

In addition, the wheel assembly includes a pressure sensor 80 and a temperature sensor 82 installed into the closed space 30. Both of these sensors are connected to a communications interface so as to enable measured values to be transmitted to the data processor unit 68. In the example described, the communications interface to which the sensors are connected is the interface of the controller. Nevertheless, the interface could be different.

The wheel assembly of the invention operates as follows.

The pressure and the temperature inside the closed space 30 are measured continuously during pre-takeoff stages and pre-landing stages. Otherwise, the taking of measurements is inhibited when the landing gear is retracted in order to economize the energy needed to operate the sensors.

The measured values of pressure P and temperature T are sent to the data processor unit 68 via the complementary wireless communications means.

The data processor unit 68 also receives a reference tire pressure Pᵤ from other functional elements of the airplane.

The computer 70 corrects the measured pressure P as a function of the measured temperature T in order to convert the pressure value to normal temperature conditions, i.e. to a temperature of 25° C. The resulting corrected pressure, written P_{c} is compared with the reference pressure Pᵤ received by the data processor unit 68.

If the corrected pressure P_{c} is greater than the reference pressure, then the data processor unit 68 sends a command to the controller 62 to open the vent valve 58 in order to allow gas contained in the closed space 30 to flow out. The valve 58 is reclosed when the corrected pressure P_{c} reaches the reference pressure Pᵤ.

In contrast, if the corrected pressure value P_{c} is less than the reference pressure value Pᵤ, the controller 62 receives a command from the data processor 68 to open the valve 52 so as to allow nitrogen to flow from the reservoir 40 into the closed space 30. The valve 52 is reclosed once the corrected pressure P_{c} in the closed space 30 reaches the reference pressure Pᵤ.

It will be understood that the presence of the reservoir 40 of gas under pressure on the rotary portion of the wheel makes it possible to avoid complex coupling between the closed space defined by the tire and a supply of gas secured to the vehicle.

FIGS. 2 to 4 show variant embodiments of the FIG. 1 wheel assembly. In these figures, elements that are identical or analogous to those of FIG. 1 are designated by the same reference numerals.

In the embodiment of FIG. 2, the selective connection means 50 and the vent means 56 comprise a single three-port and three-position valve replacing the valves 52 and 58.

The three-port valve designated by overall reference 100 is disposed, for example, inside the reservoir 40. A first port 102 is connected to the closed space 30 through the ring 24. A second port 104 is connected to the inside of the reservoir 40, while the third port 106 is connected to ambient air.

The valve selector, constituted for example by a rotary slide 108, is adapted so that in a first position it closes all three ports 102, 104, and 106. In a second position, the first and second ports 102 and 104 are connected to each other while the third port 106 is closed, so that gas under pressure contained in the reservoir 40 can flow into the closed space 30 defined by the tire.

In a third position, the first and third ports 102, 106 are interconnected, with the second port 104 being closed, such that the closed space 30 is connected to ambient air, thus enabling the gas inside the closed space 30 to flow out into the atmosphere.

The selector 108 of the three-port valve is controlled from the controller 62 so as to move between its three positions as a function of the command received from the data processor unit 68.

In the embodiment of FIG. 3, the reservoir 40 is not disposed along the arms 26 of the rim outside the tire, but is disposed instead inside the closed space 30. The reservoir 40 is thus disposed between the two sidewalls referenced 18A and 18B of the tire.

In this case, the filler valve 42 for the reservoir and the safety valve 44 are disposed through the outer ring 24 of the rim, while the valve 52 of the means for selectively connecting the reservoir 40 to the closed space 30 is disposed directly at an outlet from the reservoir into the closed space 30.

In this embodiment, the toroidal reservoir 40 disposed inside the space 30 defines a bearing surface 40A for the tread of the tire in the event of a puncture, thereby enabling the punctured tire to retain its shape.

The embodiment of FIG. 4 differs from that of FIG. 1 solely in that communication between the data processor unit 68 and the controller 62 is not provided by radio but instead through a rotary transformer given overall reference 120.

This transformer comprises a first winding 122 constrained to rotate with the rim 16. It also comprises a second winding 124 located inside the first winding 122, the two windings being disposed coaxially about the wheel axis. The second winding 124 is secured to the wheel axle (not shown).

The first winding 122 is connected to the controller 62 by a wire connection 126. The second winding 124 is connected by a wire connection 128 to the data processor unit 68.

In this embodiment, the measurements taken by the sensors 80 and 82, and also the commands are carried by the wire connections 124 and 126, and they are conveyed between the stationary portion and the rotary portion via the rotary transformer 120.

1-11. (canceled)

12. A vehicle wheel assembly comprising a rim (16) and a tire (18) defining between them a closed space (30) filled with gas under pressure, a reservoir (40) of gas under pressure, and means (50) for selectively connecting the reservoir (40) of gas under pressure to the closed space (30) defined between the rim (16) and the tire (18), wherein the reservoir (40) of gas under pressure is constrained to rotate with the rim (16), and wherein the reservoir (40) is disposed in the annular space (30) defined between the tire (18) and the rim (16).

13. A wheel assembly according to claim 12, wherein the reservoir (40) is filled with nitrogen.

14. A wheel assembly according to claim 12, including a control unit (54) connected to the means (50) for selectively connecting the gas reservoir (40) to the closed space (30) to switch them between an open state and a closed state.

15. A wheel assembly according to claim 14, including a sensor (80) for measuring the pressure inside said closed space (30), and wherein said control unit (54) is adapted to switch said connection means (50) as a function of the pressure in said closed space (30).

16. A wheel assembly according to claim 14, including a temperature sensor (82), and wherein said control unit (54) is adapted to switch said connection means (50) as a function of the temperature measured by the sensor (82).

17. A wheel assembly according to claim 12, wherein said control unit (54) comprises:
a remote data processor unit (68) that does not rotate with the rim (16);
a controller (62) for controlling the means (50) for selectively connecting the reservoir (40) to the closed space (30), said controller (62) being constrained to rotate with the rim (16); and
complementary wireless communications means (64, 66, 72, 74; 122, 124) connected firstly to said data processor unit (68) and secondly to said controller (62) to transmit commands from said data processor unit (68) to the controller (62).

18. A wheel assembly according to claim 17, including a pressure and/or temperature sensor (80, 82) inside said closed space and complementary wireless communications means (64, 66, 72, 74; 122, 124) connected firstly to the or each sensor (80, 82) and secondly to said data processor unit (68) for transmitting the measured values from the or each sensor (80, 82) to said data processor unit (68).

19. A wheel assembly according to claim 17, wherein said complementary communications means comprise a rotary transformer (120) comprising two windings (122, 124) mounted to rotate relative to each other, one of the windings (122) being constrained to rotate with-the rim (16).

20. A wheel assembly according to claim 17, wherein said complementary communications means comprise two antennas (66, 74) one of which is constrained to rotate with the rim (16) and the other of which is connected to the data processor unit (68) and does not rotate with the rim (16), being situated remotely therefrom.

21. A wheel assembly according to claim 14, including means (56) for selectively venting said closed space (30), said means being connected to said control unit (54) to cause them to switch between an open state and a closed state.

22. A wheel assembly according to claim 21, wherein said means (50) for selectively connecting the reservoir (40) to said closed space (30) and said means (56) for selectively venting said closed space (30) comprise a three-port valve (100) with a first port (102) connected to said closed space (30), a second port (104) connected to the reservoir (40), and the third port (106) connected to the atmosphere, the valve (100) including a selector (108) movable between a first position in which all three ports are closed, a second position in which the first and second ports (102, 104) are put into communication, while the third port (106) is closed, and a third position in which the first and third ports (102, 106) are put into communication, while the second port (104) is closed.
